(19) United States
(12) Patent Application Publication
(10) Pub. No.: US 2012/0112459 A1
(43) Pub. Date: May 10, 2012

(54) Vertical vane wind turbine having peripheral weight distribution

(76) Inventors: Kenneth Dale Crowe, Las Vegas, NV (US); Timothy L. Puetz, Las Vegas, NV (US)

(21) Appl. No.: 12/927,301

(22) Filed: Nov. 10, 2010

(51) Int. Cl. H02P 9/04; F03D 3/06

(52) U.S. Cl. 290/44; 416/178

(57) ABSTRACT

A wind turbine system includes a turbine having a plurality of semi-cylindrical vanes supported in a cylindrical array by rotatable top, center and bottom plates. The supporting plates are joined to a center shaft which in turn is rotatably supported. A plurality of alternators are driven by the center shaft through a pulley and belt arrangement. The vanes are positioned at the periphery of the cylindrical array and occupy less than one-third of the radial distance of the support plates.

### FIELD OF THE INVENTION

This invention relates generally to wind energy systems operative to convert wind energy to electrical energy and particularly to wind turbine systems utilized therein.

### BACKGROUND OF THE INVENTION

For many years during and following the industrial revolution, the energy needs of the industrialized nations of the world have, for the most part, been satisfied by systems dependent upon the combustion of fuels such as oil, coal and natural gas. While some energy has been provided by renewable sources such as falling water, sun and wind, combustible fuel systems have so dominated the production of energy that secondary effects caused by fuel combustion such as environmental pollution and exhaustion of resources have become pressing concerns.

In response to these growing environmental and resource depletion concerns, practitioners in the energy system arts have endeavored to develop energy systems which utilize energy sources based upon non-polluting renewable sources. Such energy systems are often referred to as “green energy” systems so named for their reduced pollution or non-polluting nature. Green energy systems use various types of energy sources such as geo-thermal, wind, falling water or solar energy. Of these green energy sources, geo-thermal and falling water energy appear to be limited to certain geographical locations. Accordingly, while they may eventually produce substantial energy, they do not provide likely solutions for large scale energy creation. Solar energy on the other hand is plentiful and widely distributed upon the entire earth but is beset by limitations of current technology primarily in the efficiency of converting solar energy to electrical power.

Thus, wind energy systems appear to offer what is perhaps the most promising source for widely distributed, widely available green energy production. Wind energy systems are fundamentally simple. A wind turbine having a plurality of vanes is rotatably supported in an area typically selected for prevailing winds. The turbine is mechanically coupled to an electric generator or alternator system the output of which supplies electrical power.

In a typical wind turbine installation, a plurality of propeller-like vanes (usually three) are supported upon a vertical tower. The tower must be of sufficient height to allow clearance of the vanes above the ground as the vanes rotate under the influence of the wind. A gear system couples the rotational power of the vanes to the electrical generators or alternators.

Despite the promise offered by current wind turbine systems, several problems and limitations have been encountered. For example, the supporting tower structure must be a relatively tall high strength structure which is therefore expensive to construct.

In addition, the gear drive which couples the turbine rotational power to the electrical generation portion of the system is subject to frequent maintenance needs and problems. To avoid damage to the gear drive system and the remainder of the system, the current turbines must be periodically shut down for maintenance and lubrication. Since this maintenance and lubrication must be performed upon the gear drive system atop the supporting tower, it is difficult, expensive and time consuming. All too often, present day wind turbine systems are shut down for long periods of time awaiting necessary preventive maintenance and lubrication operations. During such shut down periods, of course, no power is being produced by the turbine which in turn negatively impacts overall system costs and efficiency.

Further problems in the operation of current wind turbine systems arise in the impact of the large rotating vanes upon certain wildlife traveling through or occupying wind turbine locations. Flying animals such as birds and bats simply do not see the high speed vanes as they rotate. As a result, these animals often collide with the turbine vanes. Such collisions usually kill the hapless animal and therefore produce an undesirable effect upon the environment. In addition however, the collisions of such flying animals may also damage the expensive turbine vanes further increasing overall system maintenance, costs and downtime.

These problems and limitations encumbering current wind turbine technology have combined to limit the full development and commercial exploitation of wind turbine systems. Thus, while present wind turbine systems have to some extent improved the art and in some instances enjoyed commercial use, there remains nonetheless a continuing and unresolved need in the art for more improved wind turbine systems which meet and overcome the problems and limitations of current wind turbine systems.

### SUMMARY OF THE INVENTION

Accordingly, it is a general object of the present invention to provide improved wind turbine systems. It is a more particular object of the present invention to provide improved wind turbine systems which utilize wind turbine structures overcoming the problems and limitations of the prior art technology.

In accordance with the present invention, there is provided a vertical vane wind turbine system comprising: a rotating turbine having a generally cylindrical structure including generally circular top and bottom plates each defining a plate radius and peripheral edge and a plurality of vanes each having opposed ends joined to the top and bottom plates; a power shaft joined to the top and bottom plates having an output end; a drive pulley coupled to the output end; a plurality of rotatable electric power producers each having a driven pulley substantially smaller than the drive pulley; and a belt drive coupling the drive pulley to the driven pulleys, the plurality of vanes being joined to the top and bottom plates at the peripheral edges and extending inwardly therefrom for a distance less than one-third of the plate radius.

The present invention further provides a vertical vane wind turbine system comprising: a turbine having a plurality of vanes each defining a concave surface and a convex surface and means for supporting the vanes in a generally cylindrical array having the concave surfaces oriented in a common direction, the generally cylindrical array defining an outer edge and a center-to-edge radius and the vanes each defining a radial width in the direction of the radius; means for rotatably supporting the turbine; a plurality of rotatable electric power producers each having a rotatable input shaft and each characterized by the production of electric power when the input shaft is rotated; and drive means coupling the turbine to the input shafts such that electric power is produced when the turbine is rotated, the plurality of vanes being positioned at the outer edge of the cylindrical array and having radial widths which extend inwardly less than one-third of the center-to-edge radius to create a weight distribution for the turbine which increases weight toward the outer portion of the generally cylindrical array.

From another perspective, the present invention provides a wind turbine system comprising: a turbine having a plurality of vanes each defining a concave surface and a convex surface and means for supporting the vanes in a generally cylindrical array having the concave surfaces oriented in a common direction, the generally cylindrical array defining an outer edge and a center-to-edge radius and the vanes each defining a radial width in the direction of the radius; means for rotatably supporting the turbine; at least one rotatable electric power producer having a rotatable input shaft and characterized by the production of electric power when the input shaft is rotated; and drive means coupling the turbine to the at least one input shaft such that electric power is produced when the turbine is rotated, the plurality of vanes being positioned at the outer edge of the cylindrical array and having radial widths which extend inwardly less than one-third of the center-to-edge radius to create a weight distribution for the turbine which increases weight toward the outer portion of the generally cylindrical array.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a broken section perspective view of a vertical vane wind turbine constructed in accordance with the present invention;

FIG. 2 sets forth a partial section side elevation view of the turbine portion of the present invention vertical vane wind turbine;

FIG. 3 sets forth a section view of the present invention wind turbine taken along section lines 3-3 in FIG. 2;

FIG. 4 sets forth a section view of the present invention wind turbine taken along section lines 4-4 in FIG. 2;

FIG. 5 sets forth a section view of the present invention wind turbine taken along section lines 5-5 in FIG. 2;

FIG. 6 sets forth a partial section view of the present invention vertical vane wind turbine taken along section lines 6-6 in FIG. 2;

FIG. 7 sets forth a block diagram of the operative circuitry within the present invention vertical vane wind turbine;

FIGS. 8A and 8B set forth perspective views of typical vane-to-top and bottom plate attachments (FIG. 8A) and a vane-to-center plate attachment (FIG. 8B) of the present invention vertical vane wind turbine; and

FIG. 9 sets forth a perspective assembly view of a shaft coupler of the present invention vertical vane wind turbine.

### DESCRIPTION OF THE PREFERRED EMBODIMENT OF THE INVENTION

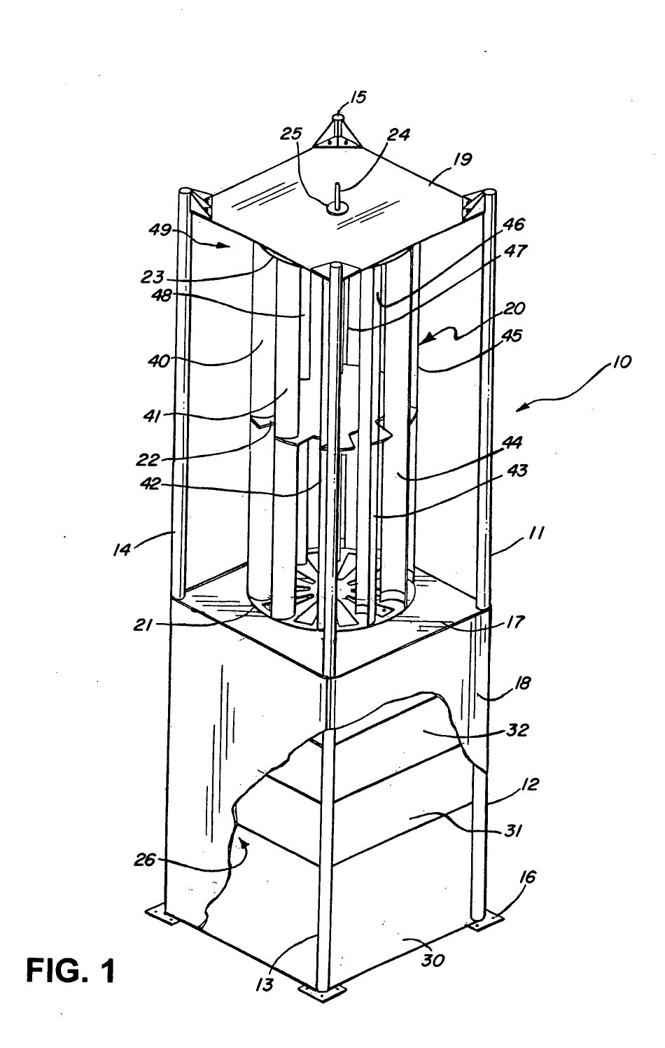

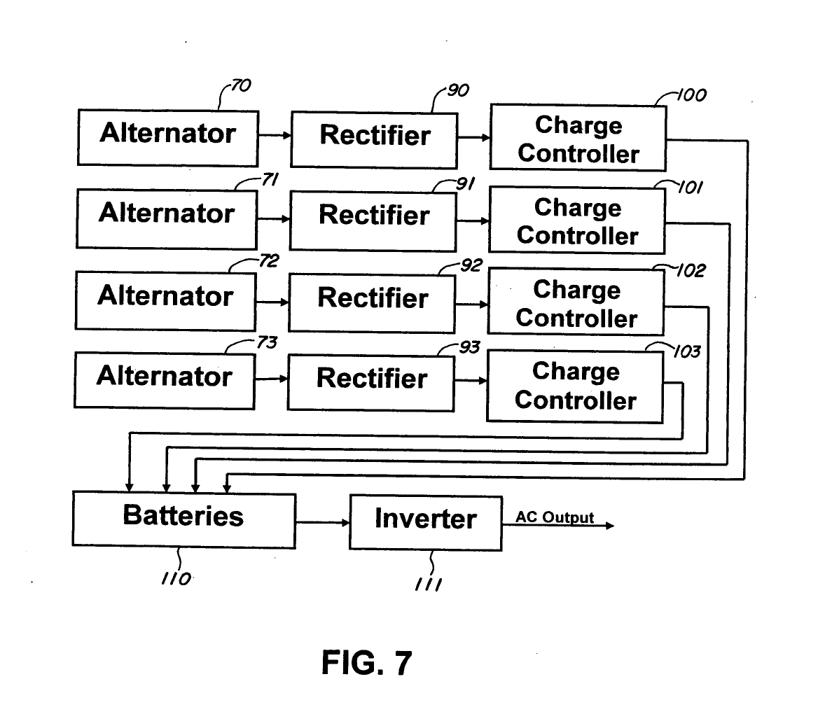

FIG. 1 sets forth a broken section perspective view of a vertical vane wind turbine system constructed in accordance with the present invention and generally referenced by numeral 10. Turbine system 10 includes a supporting frame 11 having a plurality of vertical supports 12, 13, 14 and 15 each having a supporting foot 16 on the lower end thereof and each extending vertically to be joined to a support top 19. The attachments of frame supports 12 through 15 to feet 16 and top 19 is carried forward utilizing conventional fastener attachments such as threaded fasteners or the like. A cover 18 and a base 17 enclose the lower portion of support frame 11 to provide protective enclosure for a group of electronic circuit components 30, 31 and 32. The arrangement and operation of circuit components 30, 31 and 32 are set forth and described below in greater detail in conjunction with FIG. 7. However, suffice it to note here that electronic circuit components 30, 31 and 32 are arranged in a supporting rack within cover 18 of support frame 11 and are fabricated in accordance with conventional fabrication techniques. Cover 18 also provides a protective environment forming internal compartment 26 to house components 30, 31 and 32.

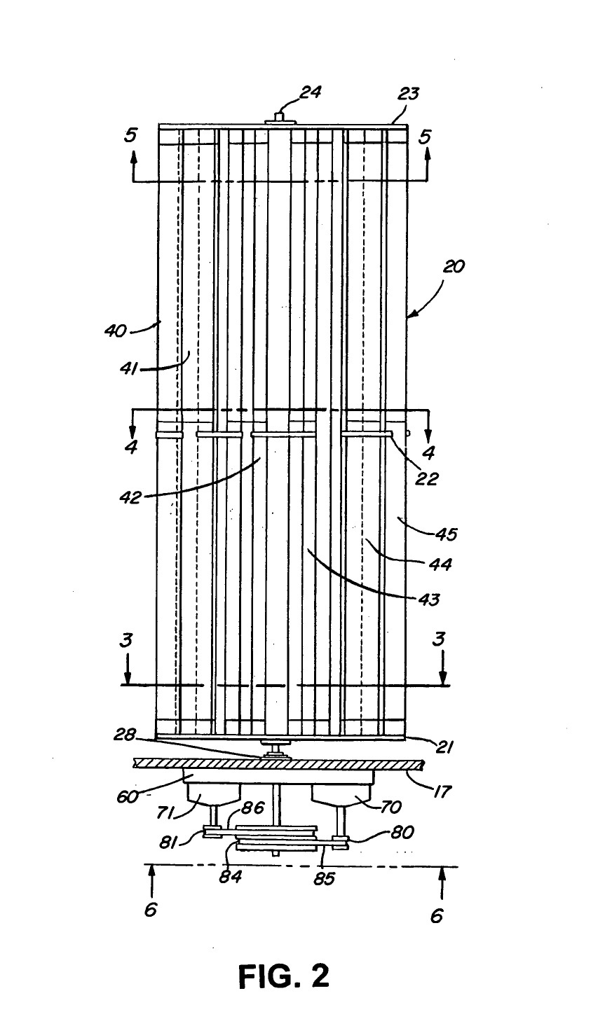

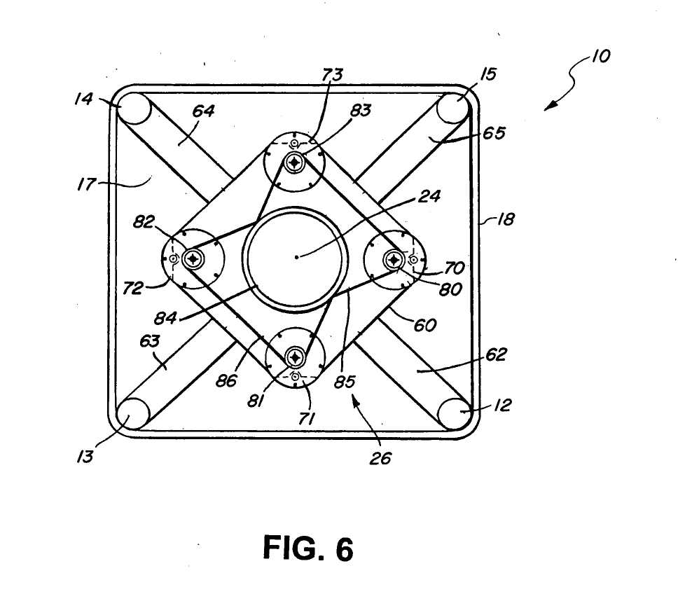

Turbine system 10 further includes a wind turbine 20 fabricated in accordance with the present invention and formed of a top plate 23, a center plate 22 and a bottom plate 21. Plates 21 through 23 define generally circular outer periphery and are joined to a plurality of vanes 40 through 49. Vanes 40 through 49 are vertically arranged and defined generally semi-cylindrical structures each joined at their respective ends to plate 21 and top plate 23 to form turbine 20. Additionally, vanes 40 through 49 are further joined to center plate 22 for additional strength and rigidity. The detailed structure of turbine 20 is set forth below in greater detail in FIG. 2 through 5. However, suffice it to note here that turbine 20 forms a generally cylindrical vertical array of turbine rays all joined together and all rotatably supported by a power shaft 24. A plurality of bearings such as bearings 25 provide rotational support for power shaft 24. As is better seen in FIGS. 2 and 6, turbine 20 is mechanically coupled to a plurality of alternators to convert the rotation of turbine 20 to electrical power. Thus, turbine 20 is rotatably supported within frame 11 and is exposed to prevailing winds to convert wind energy to electrical power.

The fundamental operation of turbine system 10 is provided by the structure of vanes 40 through 48. Each vane defines a convex surface and an opposed concave surface. In the embodiment of the present invention set forth in FIG. 1, vanes 40 through 49 form generally semi cylindrical structure. However, it will be apparent to those skilled in the art that some variation of vane structure may be utilized so long as the cooperating set of convex and concave surfaces is provided by the vanes. In the fundamental operation of the present invention wind turbine system, wind traveling through and around the turbine structure tends to engage the concave surface of the vanes more than the convex surfaces. As a result, a net force is applied to the vanes by prevailing wind to impart rotational torque to the turbine. The speed of turbine rotation is substantially dependent upon the prevailing wind speed. By means set forth below in greater detail, the wind driven rotation of turbine 20 provides rotational torque which in turn drives a plurality of alternators to produce electrical energy. My means also described below in greater detail, the raw electrical energy output of the alternators is processed by the wind turbine system electronic components to produce a clean generally constant frequency electrical power output which is suitable for coupling to the electronic power grid or for local use driven by the wind turbine system.

FIG. 2 sets forth a partially sectioned side elevation view of turbine 20 showing its coupling to a plurality of alternators such as alternators 70 and 71. As described above, vertical vane wind turbine 20 comprises a plurality of semi-cylindrical vanes 40 through 49 (vanes 46 through 49 seen in FIGS. 3 through 5) each having opposed ends joined to a top plate 23 and a bottom plate 21. As is also described above, vanes 40 through 49 are further joined to a center plate 22 which provides resistance to vane twisting and flexing during operation. In further accordance with the present invention, top plate 23, bottom plate 21 and an intermediate plate 22 are each joined to power shaft 24 in the manner set forth below in FIG. 9. Intermediate plate 22 is positioned to provide additional direct coupling of vanes 40 through 49 to shaft 24. In a typical installation, intermediate plate 22 is generally centered on vanes 40 through 49 and is therefore usually referred to herein as “center plate 22”. Additionally, it is recognized that the present invention wind turbine may utilize a plurality of intermediate plates spaced along the vanes. Suffice it to note here that plates 21, 22 and 23 which supports vanes 40 through 49 are directly coupled to power shaft 24. Additionally, turbine 20 is rotatably supported with respect to base 17 by a plurality of conventional bearings such as bearing 28 operable upon shaft 24. In further accordance with the present invention, a mounting plate 60 is secured to base 17 and further supports a plurality of alternators 70, 71 and 72 and 73 (alternators 72 and 73 shown in FIG. 6). In further accordance with the present invention, the bottom end of output shaft 24 is joined to a drive pulley 84. As is better seen in FIG. 6 drive pulley 84 is operatively coupled to driven pulleys 80 through 83 respectively coupled to alternators 70 through 73 utilizing a pair of continuous belts 85 and 86.

Returning to FIG. 2, it will be noted that the entire structure of vertical vane turbine 20 is rotatably supported and directly coupled to drive pulley 84. Pulley 84 is a double pulley that is coupled by a pair of flexible belts to a plurality of pulleys each supported upon the input shafts of their respective alternators. As a result rotation of vertical vane turbine 20 under the influence of prevailing wind provides a rotational torque which utilized in rotating alternators 70 through 73 thereby producing electrical power output. The utilization of a relatively large diameter drive pulley 84 coupled to output shaft 24 and a plurality of smaller diameter driven pulleys 80 through 83 allows the present invention vertical vane wind turbine to operate with sufficient speed multiplication between turbine 20 and alternators 70 through 73 that the present invention systems remains efficient and effective under the influence of relatively low prevailing winds. In essence, the high torque provided by the vane structure and arrangement of turbine 20 together with the speed multiplication ratio between drive pulley 84 and driven pulleys 80 thorough 83 remains effective alternator output levels not withstanding low wind speed and low rotational speed of turbine 20.

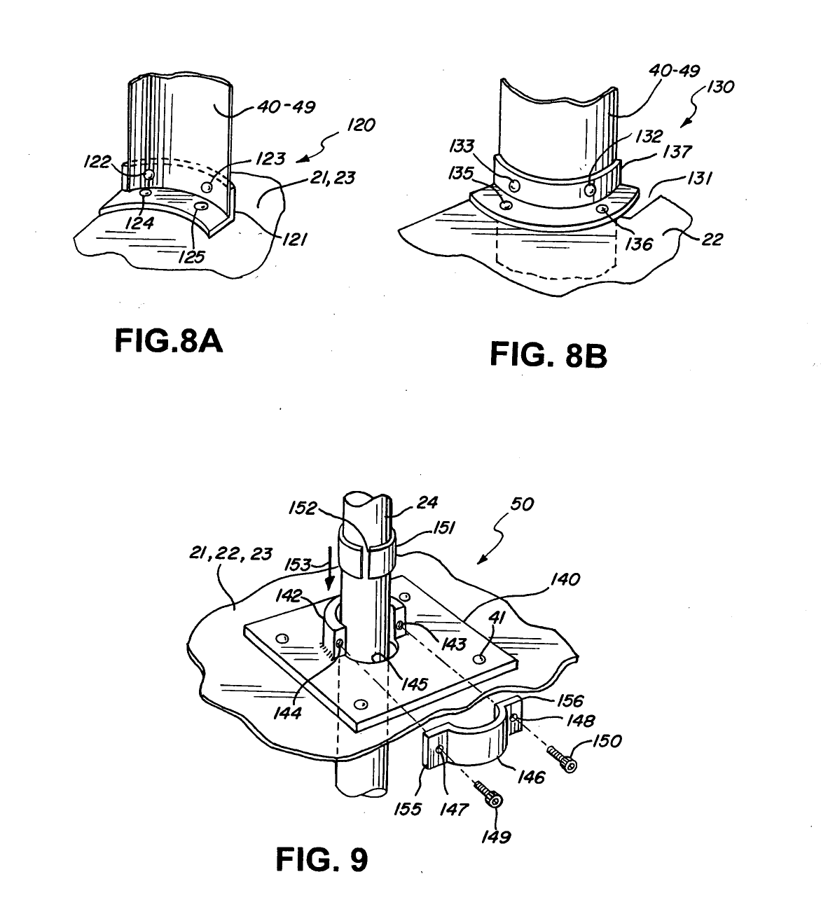

FIG. 3 sets forth a section view of turbine 20 taken along section lines 3-3 in FIG. 2. A generally circular bottom plate 21 is coupled to shaft 24 by a shaft coupler 50. The structure of shaft coupler 50 is set forth below in FIG. 9 in greater detail. Suffice it note here however, that the basic function of coupler 50 is to provide direct secure attachment of bottom plate 21 to output shaft 24. In accordance with the present invention. A plurality of generally semi-cylindrical vanes 40 through 49 are joined to the upper surface of bottom plate 21 in a rigid attachment. Vanes 40 through 49 may be directly joined to plate 21 by attachment methods such as welding or the like. Alternatively, vanes 40 through 49 may be joined to bottom plate 21 utilizing a plurality of vane attachment brackets such as the vane attachment bracket shown in FIG. 8. Of importance with respect to the present invention is the relative size and location of vanes 40 through 49 relative to the diameter of bottom plate 21. In accordance with an important aspect of the present invention, vanes 40 through 49 are positioned at or near the periphery of bottom plate 21 and extend inwardly for a relatively short distance. This places the weight distribution provided by vanes 40 through 49 as far outwardly as possible upon bottom plate 21. It has been found that the resulting weight distribution and wind characteristics provided by this arrangement and sizing of vanes 40 through 49 produces a turbine structure which provides substantial torque in the presence of slight or low speed winds greatly enhancing the efficiency and effectiveness of the resulting wind turbine.

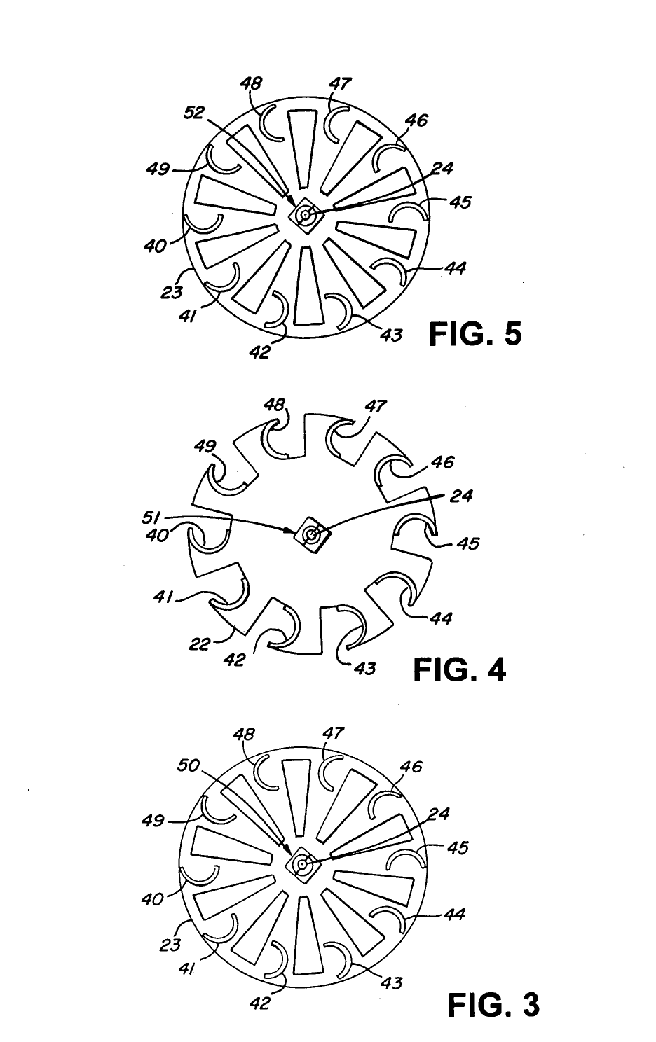

FIG. 4 sets forth a section view of turbine 20 taken along section lines 4-4 in FIG. 2. FIG. 4 shows a center plate 22 having a generally circular outer edge within which a plurality of vane receiving notches are evenly spaced. Center plate 22 further includes a shaft coupler 51 fabricated in accordance with the structure of FIG. 9 which securely joins center plate 22 to output shaft 24. The notches formed in center plate 22 allow vanes 40 through 49 to pass upwardly through the notches and facilitate the secure attachment of vanes 40 through 49 to plate 22. As mentioned above, this attachment may be facilitated utilizing a plurality of attachment brackets (not shown) similar in structure to the attachment bracket shown in FIG. 8 or alternatively may utilize direct attachment using methods such as welding or the like. The essential character of the attachment of vanes 40 through 49 to center plate 22 is to provide a rigid secure attachment which prevents twisting and flexing of vanes 40 through 49.

FIG. 5 sets forth a section view of wind turbine 20 taken along section lines 5-5 in FIG. 2. A generally circular top plate 23 which will be seen to be substantially identical to bottom plate 21 is coupled to output shaft 24 by a shaft coupler 52. Once again shaft coupler 52 is set forth below in FIG. 9 in greater detail. However, suffice it to note here that the basic function of shaft coupler 52 is to provide a direct secure attachment between top plate 23 and output shaft 24. In correspondence to bottom plate 21 shown in FIG. 3, top plate 23 receives the upper ends of vanes 40 through 49 in a secure attachment to complete the structure of wind turbine 20. Once again, the attachment of vanes 40 through 49 may be accomplished by direct attachment methods such as welding or alternatively may utilize the attachment brackets shown in FIG. 8. In either event, the essential function of attachment is to provide direct secure joining of the upper ends of vanes 40 through 49 to the undersurface of top plate 23.

With simultaneous reference to FIGS. 3, 4 and 5, an important aspect of the present invention is clearly observed in that vanes 40 through 49 occupy a small portion of the diameters of plates 21, 22 and 23. It will be further observed that the position of vanes 40 through 49 is limited to the outer one third to one quarter of the area of plates 21, 22 and 23. In this manner, the weight distribution of the present invention design is provided. This weight distribution in turn provides the extremely beneficial high torque during low wind speed operation. It will be equally apparent to those skilled in the art that to avoid unduly cluttering the figures, the attachments of vanes 40 through 49 to plates 21, 22 and 23 has been omitted from the figures. Once again it will be understood that these attachments may be accomplished utilizing conventional welding attachments or alternatively utilizing brackets such as the attachment brackets shown in FIG. 8.

FIG. 6 sets forth a partial section view of vertical vane wind turbine system 10 taken along section lines 6-6 in FIG. 2. In essence, FIG. 6 is a “bottom view” of the operative structure of turbine 20 and provides illustration of the positioning of the alternators utilized in the present invention turbine system. More specifically, wind turbine system 10 includes a plurality of vertical supports 12, 13, 14 and 15 having a surrounding cover 18 secured thereto. A base 17 is joined to cover 18 to provide a complete enclosure and form an internal compartment 26. As will be recalled in conjunction with FIG. 1, compartment 26 receives and supports electrical circuit components 30, 31 and 32. Returning to FIG. 6, a mounting plate 60 is secured within compartment 26 beneath base 17 by a plurality of support braces 62, 63, 64 and 65 each of which is secured to mounting plate 60 and extends outwardly to a corresponding support. Thus, support brace 62 is joined to support 12, support brace 63 is joined to support 13, support brace 64 is joined to support 14 and support brace 65 is secured to support 15. This positions mounting plate 60 within interior compartment 26 in a generally centered arrangement. Mounting plate 60 further supports a plurality of alternators 70, 71, 72 and 73. Alternators 70 through 73 have respective driven pulleys 80 through 83 coupled to the output shafts of the alternators. Output shaft 24 of turbine 20 extends downwardly through mounting plate 60 and supports a drive pulley 84. Drive pulley 84 is a double pulley and is positioned within the common plane of pulleys 80 and 83 and of pulleys 81 and 82. A flexible endless belt 85 is received upon drive pulley 84 and driven pulleys 80 and 83. A second flexible endless belt 86 is also received upon drive pulley 84 and driven pulleys 81 and 82. The use of oppositely oriented flexible belts 85 and 86 balances the lateral forces upon drive pulley 84 and shaft 24.

In operation, as shaft 24 rotates drive pulley 84, driven pulleys 80 through 83 are correspondingly rotated to drive alternators 70 through 73 and produce electrical power. It has been found that the pulley and belt drive used in the embodiment shown has advantages of quiet smooth operation and speed multiplication. The use of speed multiplication is particularly advantageous under low wind conditions. However, it is recognized that a speed multiplying gear drive may be used in some installations.

FIG. 7 sets forth a block diagram of the electrical power circuit of the present invention vertical vane wind turbine. It will be noted that the electrical circuit components set forth in the block diagram of FIG. 7 are supported within the present invention vertical vane wind turbine system in the manner shown in FIGS. 1 and 2. Specifically, the present invention vertical vane wind turbine includes a plurality of alternators 70, 71, 72 and 73 supported within wind turbine system 10 in the manner shown in FIG. 2. While a variety of conventional alternators may be utilized in practicing the present invention, the embodiment set forth in FIGS. 1 through 6 utilizes alternators manufactured by Ginlong Model No. GI-PNG-1500. Alternators 70, 71, 72 and 73 produce output voltages which are applied to a corresponding plurality of rectifiers 90, 91, 92 and 93. Rectifiers 90 through 93 are fabricated in accordance with conventional fabrication techniques and produce output voltages which are applied to a plurality of charge controllers 100, 101, 102 and 103. While various types of charge controllers are available for use in the present invention system, the embodiment set forth in FIGS. 1 through 6 utilizes charge controllers manufactured by Outback Power Systems Inc. Model Flexmax 80. The output of charge controllers 100 through 103 are coupled to a battery pack 110. Battery pack 110 typically includes a plurality of batteries which may utilize a combination of series and parallel coupled batteries to provide the desired current capacity and output voltage to drive inverter 111. Inverter 111 receives the output voltage of battery pack 110 and converts it from a DC voltage to an AC output voltage which is relatively constant in frequency and free of noise and distortion in order to satisfy the requirements of a conventional electrical power grid input. In the United States for example, power applied to the electrical power grid must be 60 Hz sinusoidal and relatively noise free to meet system input requirements. The voltage of AC power to be applied to the grid is a function of the type of input apparatus utilized by the electrical power grid.

In the embodiment of the present invention shown in FIG. 7, a battery output voltage to inverter 111 of twenty four volts DC has been selected. Thus, battery pack 110 includes a total of twelve batteries arranged in three groups of four series connected batteries in each group. The three groups are then coupled in a parallel arrangement to provide a high current twenty four DC output to inverter 11. It will be apparent to those skilled in the art however that different voltages and different battery combinations may be utilized without departing from the spirit and scope of the present invention. In accordance with this embodiment, battery pack 110 utilizes batteries manufactured by Trojan having Model No. LP-16 which comprise six volt lead acid batteries. Once again however, different batteries may be utilized without departing from the present invention.

In operation, as wind turbine 20 (seen in FIG. 2) rotates under the power of prevailing wind, alternators 70, 71, 72 and 73 are rotated by the pulley arrangement shown in FIG. 6. It will be recalled that the pulley arrangement utilized in the present invention system accommodates relatively low-speed high-torque rotation of wind turbine 20 (seen in FIG. 2) and employs a speed multiplication in the belt drive and pulley arrangement which couples rotational power from the wind turbine to the quartet of alternators. Thus, as alternators 70 through 73 are rotated, they produce respective AC voltage outputs which are rectified by rectifiers 90 through 93 respectively to convert the alternator outputs from AC to DC voltage. The DC voltages from rectifiers 90 through 93 are applied to charge controllers 100 through 103 respectively. Charge controllers 100 through 103 operate in accordance with conventional fabrication techniques to maintain the appropriate charging voltages for battery pack 110. It will be recognized that the output levels of alternators 70 through 73 varies as different wind speeds energize the wind turbine. The variation in electrical power outputs of alternators 70 through 73 necessitates the use of charge controllers 100 through 103 to protect the batteries within battery pack 110 from excessive charging and damage. The DC output voltage from battery pack 110 is converted to the above-described AC output power suitable for application to localized use or application to a conventional electrical power grid.

FIGS. 8A and 8B set forth partial perspective views showing the attachment of each of the vanes within the present invention wind turbine to top and bottom plates 21 and 23 and center plate 22. It will be apparent to those skilled in the art that the end portions of vanes 40 through 49 (seen in FIGS. 3 through 5) are secured to top and bottom plates 21 and 23 utilizing the bracket attachment set forth in FIG. 8A. It will be equally apparent to those skilled in the art that vanes 40 through 49 (seen in FIGS. 3 through 5) are each attached to center plate 22 in the manner shown for attachment in FIG. 8B. It will be understood however, that depending upon the fabrication choices to be exercised by fabricators, the vanes of the present invention wind turbine may be secured to their respective top, bottom and center plates utilizing other attachment mechanisms such as welding or the like.

More specifically, FIG. 8A sets forth the attachment utilized in the present invention wind turbine for securing the ends of vanes 40 through 49 to either bottom plate 21 or top plate 23 (seen in FIG. 2) which is generally referenced as attachment 120. Attachment 120 utilizes a curved bracket 121 having a generally “L-shaped” cross section which defines a curvature corresponding to the semi-cylindrical curvature of vanes 40 through 49. A pair of fasteners 124 and 125 secure the lower portion of bracket 121 directly to bottom plate 21 and top plate 23. Similarly, the end portion of vanes 40 through 49 is received upon bracket 121 and secured to the upper wall of bracket 121 by a pair of conventional fasteners 122 and 123. Fasteners 122 through 125 utilize conventional fasteners such as threaded fasteners or the like.

FIG. 8B sets forth a perspective view of an attachment 130 utilized in securing the center portions of vanes 40 through 49 of the present invention wind turbine to center plate 22 (seen in FIG. 2). As is best seen in FIG. 4, center plate 22 defines a plurality of notches within which vanes 40 through 49 are situated. Accordingly, attachment 130 uses an oppositely curved bracket 137 which defines a “L-shaped” cross section and which is secured to center plate 22 by a pair of conventional fasteners 135 and 136. Vanes 40 through 49 are positioned against the upper wall of bracket 137 within notch 131 of center plate 22 and are secured by a pair of conventional fasteners 132 and 133. Once again, it will be apparent to those skilled in the art that a variety of conventional fasteners may be utilized in securing vanes 40 through 49 to their respective brackets without departing from the spirit and scope of the present invention. It will be further recalled that alternative fastening apparatus such as welding or the like may also be utilized.

FIG. 9 sets forth a perspective assembly view of a shaft coupler generally referenced by numeral 50 which is utilized in securing plates 20, 21 and 22 (seen in FIGS. 3 through 5) to shaft 24 of wind turbine 20 (seen in FIG. 2). Shaft coupler 50 includes a base 140 secured to plates 21, 22 and 23 by a plurality of conventional fasteners 141. Base 50 defines a center aperture 145 which is aligned with the center aperture of bottom and top plates 21 and 23 and center plate 22. Base 50 further defines a semi-cylindrical wall 142 having threaded apertures 143 and 144 formed therein. Shaft coupler 50 further includes a cap 146 having a cylindrical portion and a pair of outwardly extending tabs 155 and 156. Tabs 155 and 156 define respective apertures 147 and 148. Shaft coupler 50 further includes a generally cylindrical split collar 151 encircling shaft 24 and defining a gap 152.

Shaft coupler 50 is assembled by initially securing base 140 to the respective one of plates 21, 22 or 23 using fasteners 141 such that aperture 145 is aligned with the center aperture of the host plate. Thereafter, shaft 24 is passed through aperture 145 and the center aperture of plate 21, 22 or 23 and split collar 151 is received upon shaft 24 and moved downwardly in the direction indicated by arrow 53 into alignment with the interior portion of wall 142. Thereafter, cap 150 is mated to wall 142 such that apertures 147 and 148 are aligned with threaded apertures 144 and 143 of wall 142 respectively. Finally, a pair of conventional threaded fasteners 149 and 150 are passed through apertures 147 and 148 and threaded into passages 144 and 143 in a threaded engagement. Fasteners 149 and 150 are tightened with sufficient force to compress split-collar 151 within wall 142 and cap 146 reducing gap 152 and binding shaft coupler 50 to shaft 24.

The essential function of shaft coupler 50 is to provide secure direct attachment of bottom plate 21, center plate 22 and top plate 23 to shaft 24 for secure power coupling between the wind turbine vanes and the center power shaft. It will be apparent to those skilled in the art however that alternative attachment between the respective plates of the present invention wind turbine and the power shaft may be utilized without departing from the spirit and scope of the present invention.

The turbine portion of the present invention vertical vane wind turbine system is preferably fabricated of metal materials having sufficient weight to provide the desired weight and weight distribution characteristics which form an important aspect of the present invention wind turbine system. Thus, in some installation metal such aluminum is utilized in fabricating the vanes and plates forming the wind turbine structure while in other applications which require different sizes of wind turbine steel or other heavier and stronger metals may be utilized to suit the particular application. Of importance with respect to the present invention, is the manner in which the present invention vertical vane wind turbine system contravenes the generally prevailing art which is directed to structures which have as little weight as possible. In contrast, the present invention system utilizes heavier materials such as metal or the like to provide substantial weight within the rotating turbine of the present invention turbine system. Furthermore in contrast to prevailing systems which employ vanes extending radially for most of the edge to center distance of the turbine structure, the present invention system utilizes vanes which are sized to be situated at the outer edge of the turbine structure and to extend inwardly toward the center of the turbine structure for a small portion of the total turbine diameter. It has been found that vane dimension which is limited to twenty-five to thirty-three percent of the radius of the turbine structure provides a highly beneficial operation with particular advantage in low wind circumstances. The present invention system is capable of utilizing much lower wind speeds to produce a usable level of output electrical power due to the torque provided by heavier weight turbine structures having smaller sized vanes placed at the structure edge. The advantageous result is found in the weight distribution characteristic of the wind turbine. The high torque and low speed operative capabilities of the present invention wind turbine is further enhanced by the rotational power coupling utilized between the turbine structure and the driven alternators of the system. As described above, this power coupling utilizes a speed multiplying pulley and belt system well suited to the lower rotational speeds and high torque of the present invention wind turbine. The provision of a center plate with attachment to the vanes and the center shaft greatly strengths the turbine structure against twisting and flexing during driven operation.

It will be apparent to those skilled in the art that while the present invention is described herein as a “vertical vane wind turbine system”, other non-vertical and horizontal orientations may be utilized without departing from the spirit and scope of the present invention.

What has been shown in an improved vertical vane wind turbine system having a peripheral weight distribution and low speed operative capability which together with the high torque speed multiplying coupling between the rotating turbine and the driven alternators provides efficient operation at low wind speeds not practical in other systems.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

1. A vertical vane wind turbine system comprising:
a rotating turbine having a generally cylindrical structure including generally circular top, intermediate and bottom plates each defining a plate radius and peripheral edge and a plurality of vanes each having opposed ends joined to said top and bottom plates and each being joined to said intermediate plate at a point intermediate said opposed ends;
a power shaft joined to said top, intermediate and bottom plates having an output end;
a drive pulley coupled to said output end;
a plurality of rotatable electric power producers each having a driven pulley substantially smaller than said drive pulley; and
a belt drive coupling said drive pulley to said driven pulleys,
said plurality of vanes being joined to said top and bottom plates at said peripheral edges and extending inwardly therefrom for a distance less than one-third of said plate radius.

2. (canceled)

3. The vertical vane wind turbine system set forth in claim 3 wherein said vanes each define a concave surface and a convex surface.

4. The vertical vane wind turbine system set forth in claim 3 wherein said vanes are generally semi-cylindrical and are aligned to present said convex surfaces in a common direction of rotation.

5. The vertical vane wind turbine system set forth in claim 4 wherein said top plate, said bottom plate, said intermediate plate and said vanes are formed of metal.

6. The vertical vane wind turbine system set forth in claim 5 wherein said intermediate plate is a center plate joined to said vanes at their approximate midpoints.

7. The vertical vane wind turbine system set forth in claim 6 wherein said rotatable electric power producers are alternators and wherein said vertical vane wind turbine system includes:
a plurality of rectifiers each having an input coupled to a respective one of said alternators and a rectified output;
a plurality of charge controllers each having an input coupled to a respective one of said rectified outputs and a controlled output;
a battery pack coupled to said controlled outputs and a battery pack output; and
an inverter having an input coupled to said battery pack output converting said battery pack output to alternating current electrical power.

8. The vertical vane wind turbine system set forth in claim 7 wherein said battery pack includes a plurality of batteries.

9. A vertical vane wind turbine system comprising:
a turbine having a plurality of vanes each defining a concave surface and a convex surface and top, bottom and intermediate plates each joined to said vanes for supporting said vanes in a generally cylindrical array having said concave surfaces oriented in a common direction, said generally cylindrical array defining an outer edge and a center-to-edge radius and said vanes each defining a radial width in the direction of said radius;
means for rotatably supporting said turbine;
a plurality of rotatable electric power producers each having a rotatable input shaft and each characterized by the production of electric power when said input shaft is rotated; and
drive means coupling said turbine to said input shafts such that electric power is produced when said turbine is rotated,
said plurality of vanes being positioned at said outer edge of said cylindrical array and having radial widths which extend inwardly less than one-third of said center-to-edge radius to create a weight distribution for said turbine which increases weight toward the outer portion of said generally cylindrical array.

10. The vertical vane wind turbine system set forth in claim 9 wherein said vanes are generally semi-cylindrical and define opposed ends.

11. (canceled)

12. (canceled)

13. The vertical vane wind turbine system set forth in claim 10 wherein said means for rotatably supporting said turbine includes a center shaft extending through and joined to said top plate, said bottom plate and said intermediate plate.

14. The vertical vane wind turbine system set forth in claim 13 wherein said drive means includes a drive pulley coupled to said shaft, a plurality of driven pulleys coupled to said input shafts and at least one flexible endless belt coupling said drive pulley to said driven pulleys.

15. A wind turbine system comprising:
a turbine having a plurality of vanes each defining a concave surface and a convex surface and top, bottom and intermediate plates each joined to said vanes for supporting said vanes in a generally cylindrical array having said concave surfaces oriented in a common direction, said generally cylindrical array defining an outer edge and a center-to-edge radius and said vanes each defining a radial width in the direction of said radius;
means for rotatably supporting said turbine;
at least one rotatable electric power producer having a rotatable input shaft and characterized by the production of electric power when said input shaft is rotated; and
drive means coupling said turbine to said at least one input shaft such that electric power is produced when said turbine is rotated,
said plurality of vanes being positioned at said outer edge of said cylindrical array and having radial widths which extend inwardly less than one-third of said center-to-edge radius to create a weight distribution for said turbine which increases weight toward the outer portion of said generally cylindrical array.

16. The wind turbine system set forth in claim 15 wherein said at least one rotatable electric power producer includes at least one alternator.

17. The wind turbine system set forth in claim 16 further including:
at least one rectifier having an input coupled to said at least one alternator and a direct current rectifier output;
at least one charge controller having an input coupled to said direct current rectifier output and a charge controller output; and
a battery pack coupled to said charge controller for storing direct current electrical energy.

18. The wind turbine system set forth in claim 17 further including an inverter coupled to said battery pack for producing alternating current electrical power.
